(19) United States
(12) Patent Application Publication
(10) Pub. No.: US 2009/0174381 A1
(43) Pub. Date: Jul. 9, 2009

(54) CONTROLLER FOR A POWER SUPPLY

(76) Inventors: Martti Ojanen, Turku (FI); Hannu Virta, Paimio (FI); Simo Murtojarvi, Salo (FI); Janne Tiisanoja, Pertteli (FI)

Correspondence Address: BRAKE HUGHES BELLERMANN LLP, c/o CPA Global, P.O. BOX 52050, MINNEAPOLIS, MN, 55402, US

(21) Appl. No.: 12/344,348

(22) Filed: Dec. 26, 2008

(30) Foreign Application Priority Data
Dec. 28, 2007 (GB) GB 0725316.4

(51) Int. Cl. G05F 1/10

(52) U.S. Cl. 323/282

(57) ABSTRACT

A controller for controlling a load output. In various embodiments, the controller may include a closed loop. In some embodiments, the closed loop may have a least one controllable characteristic. In one embodiment, the controller may be configured to control the at least one controllable characteristic in response to changes in the load.

### CROSS-REFERENCE TO RELATED APPLICATION

This application claims priority under 35 U.S.C. §119 to British Patent Application GB 0725316.4, filed Dec. 28, 2007, titled “A Controller,” which is incorporated herein by reference in its entirety.

### TECHNICAL FIELD

The present invention relates to a controller and in particular, but not exclusively, to a controller for a switched mode power supply (SMPS). The present invention also relates to a control method and a computer program.

### BACKGROUND

Reference is now made to FIG. 1 which shows a simplified block diagram of an envelope restoration (ER) transmitter 1. The transmitter 1 has an amplitude modulation (AM) path and a phase modulation (PM) path. Bits to be transmitted are input to a bit to polar converter 2 that outputs an amplitude signal via a propagation delay (PD) 3 to an amplitude modulator 4. The amplitude modulator 4 converts the digital signal to an analogue signal and supplies a signal to control the output level of a power amplifier 6. This is done by using a controllable power supply 5. The controllable power supply 5 is between the output of the amplitude modulator 4 and the control input of the power amplifier 6.

The bit to polar converter 2 also outputs a phase signal via the propagation delay 3 to a frequency modulator 7. The frequency modulator outputs a signal via a phase locked loop 8 to the input of the power amplifier 6. The signal transmitted by the antenna 9 is thus generated by using both phase and amplitude components.

The power amplifier is usually a non-linear power amplifier such as a switch mode power amplifier (SMPA) or a normally linear power amplifier driven into saturation. In these known arrangements, the amplitude information is provided by modulating the supply voltage to the power amplifier by using a power regulator that is connected between a DC supply or power source, such as a battery and the power amplifier.

In the known systems, the output of the power supply 5 should be capable of tracking a varying reference voltage. The reference voltage may vary relatively rapidly. Accordingly, it is generally desired that the power supply 5 meets certain bandwidth specifications. The required bandwidth depends on the system in which the transmitter is used.

Various proposals are known to implement the power supply. For example, a linear regulator implemented with a summing junction, a driver and a power device is known. This arrangement does permit a relatively high bandwidth to be obtained but the arrangement has a relatively low efficiency due the voltage drop across the power device.

Another known arrangement uses a switch mode regulator. A step down switching regulator may include a Buck type or similar converter and voltage mode control circuitry. The efficiency of such an arrangement may be relatively high but the required bandwidth may be difficult to obtain.

Reference is also made to U.S. Pat. No. 7,058,373. This arrangement describes a DC-DC converter that has a switch mode part for coupling between a DC source and a load. In parallel with the switching part is a linear part which is also connected between the DC source and the load. The switching part provides a first proportion of the output power and the linear part provides a second portion of the output power. The ratio of the power provided by the switching part and the linear part can be varied. Generally, the switching part provides a greater proportion of the output power.

Buck type converters are known. In the Buck converter, a capacitor acts as the voltage source to maintain the output voltage constant. When the voltage of the output is required to be increased, a large current must be provided via an inductor to meet the increased demand of the load and to charge the capacitor to the new higher voltage level. This operation makes the switching regulator slow and limits the bandwidth.

If only high current power switches are controlled in a so-called open loop configuration with only the LC low pass filter at its output and the pulse width modulator in the input of the high current switches driver stage, then only a very limited bandwidth can be provided in an amplitude modulator signal path or in any similar voltage control signal path.

Generic step down converters have been used so that the converter defines a closed loop. The loop is closed by an error amplifier with its output being a result of a comparison between a feedback voltage and a reference voltage. The rest of the voltage can be fixed or slowly changed. This then further controls the converter's output voltage.

However, this does not address the issue of being able to have deal with a wide bandwidth.

It is an aim of some embodiments of the invention to address or at least mitigate one or more of the above described problems.

### SUMMARY

According to one general aspect, a controller for controlling a load output. In various embodiments, the controller may include a closed loop. In some embodiments, the closed loop may have a least one controllable characteristic. In one embodiment, the controller may be configured to control the at least one controllable characteristic in response to changes in the load.

According to another general aspect, in combination with other elements a controller for controlling a load output. In various embodiments, the controller may include a closed loop. In some embodiments, the closed loop may have a least one controllable characteristic. In one embodiment, the controller may be configured to control said at least one controllable characteristic in response to changes in said load and an amplifier.

According to another general aspect, a device may include in combination with other elements a controller for controlling a load output. In some embodiments, the controller may include a closed loop. In one embodiment, the closed loop may have a least one controllable characteristic. In various embodiments, the controller may be configured to control said at least one controllable characteristic in response to changes in said load and an amplifier.

According to another general aspect, a chip set may include a controller for controlling a load output. In various embodiments, the controller may include a closed loop. In some embodiments, the closed loop may have a least one controllable characteristic, and may be configured to control said at least one controllable characteristic in response to changes in said load.

According to another general aspect, a method for controlling a load output. In some embodiments, the method may include controlling at least one controllable characteristic in a closed loop in response to changes in said load.

According to another general aspect, a controller for controlling a load output. In various embodiments, the controller may include a closed loop. In some embodiments, the closed loop may have a least one controllable characteristic. In one embodiment, the controller may include a means for controlling said at least one controllable characteristic in response to changes in said load.

According to another general aspect, a computer program product may include a computer usable medium having a computer readable program code embodied therein. In one embodiment, the computer readable program code may be adapted to be executed to implement a method for controlling a load output. In various embodiments the method may include controlling at least one controllable characteristic in a closed loop in response to changes in said load.

The details of one or more implementations are set forth in the accompanying drawings and the description below. Other features will be apparent from the description and drawings, and from the claims.

### BRIEF DESCRIPTION OF THE DRAWINGS

For a better understanding of the present invention and as to how the same may be carried into effect, reference will now be made by way of example only to the accompanying drawings in which:

FIG. 1 is a block diagram of a conventional envelope restoration radio frequency (ER RF) transmitter;

FIG. 2 shows a switch mode power supply embodying the present invention;

FIG. 3 shows a schematic diagram of the switch mode power supply of FIG. 2 in a step down mode;

FIG. 4 schematically shows a system in which embodiments of the present invention may be implemented;

FIG. 5a shows a first graph of gain versus delay;

FIG. 5b shows a first graph of delay versus frequency;

FIG. 6a shows a second graph of gain versus delay; and

FIG. 6b shows a second graph of delay versus frequency.

### DETAILED DESCRIPTION

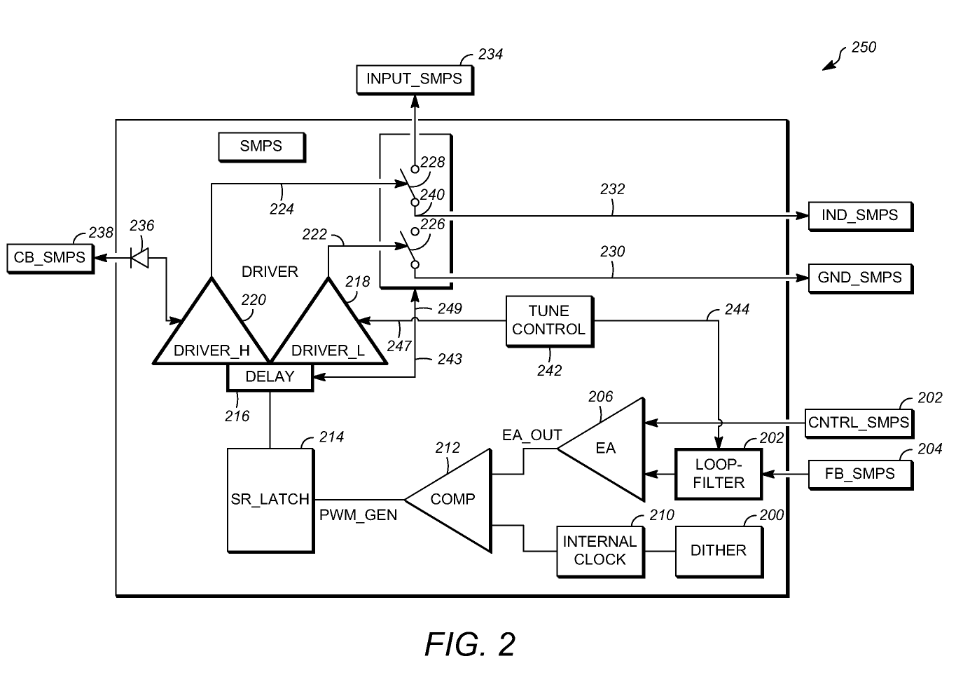

Reference is made to FIG. 2 which shows a switch mode power supply (SMPS) 250 based on the so-called Buck type converter. The Buck type converter is a step down converter and is used for voltage conversion.

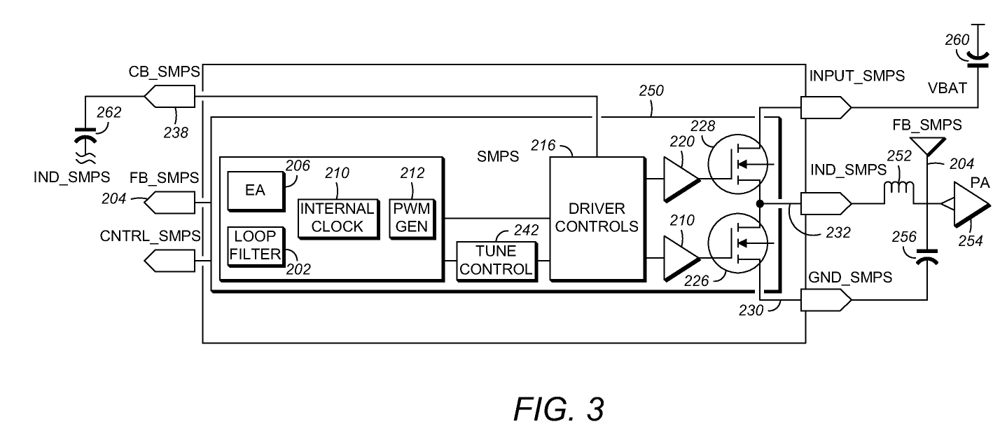

The SMPS 250 comprises a loop filter 202. The loop filter 202 is arranged to receive an input signal FB_SMPS 204. This is a feedback signal of the SMPS 250. This signal will be discussed in relation to FIG. 3.

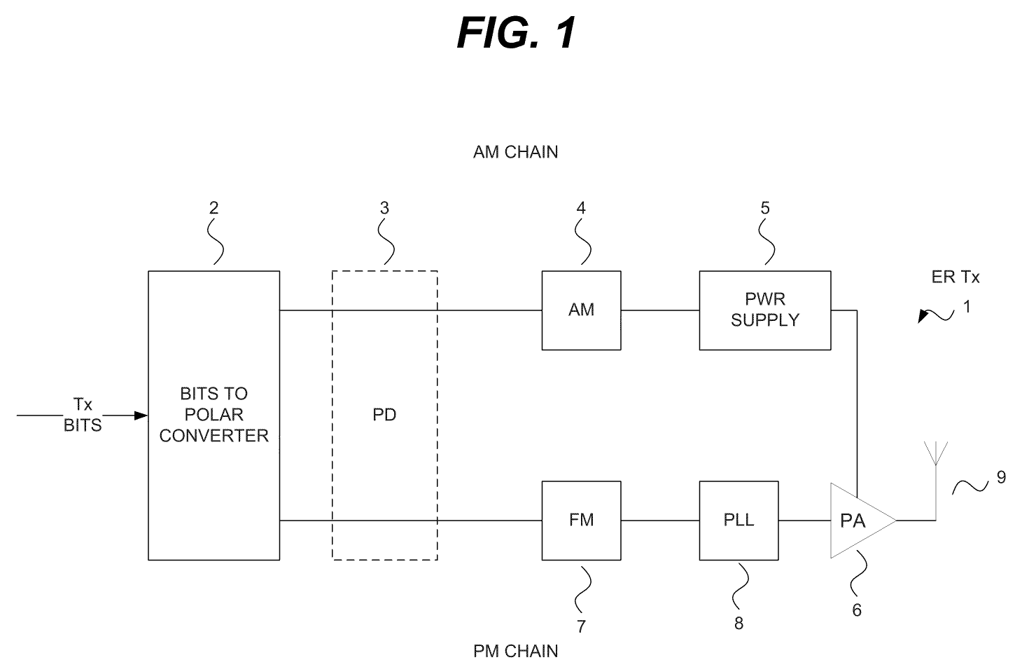

The output 208 of the loop filter is input to an error amplifier 206. The error amplifier 206 is arranged to receive a second input CNTRL_SMPS 202. This represents a control or reference signal. This signal will be of a fast changing signal first for ramping up transmission TX power, for instance in GSM (Global System for Mobile communication) system, and then steady for a certain period of time when a TX power is set ON and then ramped down. In another case, in a WCDMA (wideband code division multiple access) system, fast enable is needed for power tracking PT for efficient optimization to set the power amplifier PA collector voltage. Thus the SMPS gives a DC level that is enough for the RF peak power and is changed according to the power level. An AGC Automatic Gain Control (not shown) may control the TX power level. The AGC would be provided between the PLL 8 and PA6 of FIG. 1. In another example, the signal may also be changing in a relatively fast manner in the small-signal domain such as in envelope elimination and restoration EER or in envelope tracking ET. The error amplifier 206 is part of the loop filter defined by parts of the SMPS. The error amplifier may provide an error correction according to the control voltage and the feedback voltage.

The error amplifier 206 provides the error correction output to the input of a comparator 212. The comparator 212 receives a second input signal from an internal clock 210 with a triangle reference waveform. The internal clock 210 is controlled by a dither circuit 200 connected to the input of the internal clock 210. It should be appreciated that in some embodiments, when changing a L-C combination, in addition to setting the switching frequency of the SMPS the dither circuit may be used to attenuate the switching noise of the SMPS (by effectively spreading spurious energy over wider bandwidth instead of using a single switching frequency that causes switched mode power supply's output to exhibit a periodic ripple voltage). The output of the comparator 212 is input to a SR set reset latch. The comparator 212 and SR latch 214 effectively act as a pulse width modulator Thus, the output of the error amplifier 206 is input to the pulse width modulator which causes the pulse width modulation signal to follow the changes in the control signal up to the unity gain bandwidth frequency of the loop filter gain response.

The output of the latch 214 is connected to the input of a delay block 216. The output of the delay block 216 is connected to the input of first and second drivers 218 and 220. The delay block 216 controls the timing of the driving signals provided by the drivers 218 and 220.

The first driver 218 is the low signal driver and the second driver 220 is the high signal driver. The output 222 of the first driver 218 is used to control a first switch 226 whilst the output 224 of the second driver 220 is used to control a second switch 228.

The switches 226 and 228 can take any suitable form. In one embodiment of the invention, the switches comprise transistors. The transistors may be of the same conductivity type or of different conductivity types. In one embodiment of the present invention, the switches comprise high current switches. One example of a high current switch is a NLDEMOS switch (N-type lateral double diffused with drain extension metal oxide switch). However, these switches can be any other type of MOS switch, bipolar switch, GaAs (Gallium Arsenide) switch or the like. The switches need not to be transistors and may for example be any other suitable type of any electrical switch. Preferred embodiments of the present invention have the switches being in the form of power switches.

The switches 226 and 228 are arranged in series. The first switch 226 is connected to ground at one end of its channel. The other end of its channel is connected to a node 240. Also connected to this node 240 is one end of the channel of the second switch 228. The other end of the channel of the second switch 228 is fed by a supply voltage input INPUT_SMPS 234. It should be appreciated that the first and second drivers 218 and 220 are connected to the control terminal (e.g. gates) of the switches 226 and 228. The first and second drivers 218 and 220 control whether the switches are on or off. The timing of the signals provided by the drivers is controlled by the delay block which inhibits the switches 228 and 226 from conducting simultaneously.

Node 240 is arranged to provide an output 232 for the inductor IND_SMPS as will be discussed in more detail.

A tune controller 242 is provided. The tune controller 242 is arranged to have a first output 244 connected to the loop filter 202. The tune controller 242 is arranged to have a second output connected to the delay block. The tune control can be controlled by software, or it can be hardware coded inside the SMPS. Software can have a look-up table to handle different modes of operation. Additionally or alternatively, a conditional control of modes of operations is possible. When the control unit of the tune controller 242 is software controlled (and is inside the SMPS) then the commands must be sent to the SMPS, or it can listen to the command which set the RF-IC radio frequency integrated circuit and PA in the correct transmission mode.

The tune controller also has inputs 249 and 247 to the switches and their drivers. These inputs are used to select a number of transistors to be used in switches block according for instance to the power level of PA. At the same time, the driver stages 218 and 220 are set accordingly to have their driving capability changed.

Reference is made to FIG. 3 which shows the SMPS 250 connected to external components. In particular, the output 232, IND_SMPS, is input to an inductor 252. The output of the inductor 252 is connected to a power amplifier 254. The power amplifier 254 is also connected to a capacitor 256 the other end of which capacitor is connected to the GND_SMPS output 230.

The SMPS 250 can be used as the power supply 5 shown in FIG. 1. The power amplifier 254 would then correspond to amplifier 6 of FIG. 1.

The external components also comprise a battery 260. The feedback signal 204 is taken from the input to the power amplifier 254 and is input to the loop filter. The input supply voltage node INPUT_SMPS provides needed input current through the SMPS to supply the needed output power to the collector of the PA.

A CB_SMPS signal 238 is coupled to the IND_SMPS signal via a capacitor 262, which is charged up to a bootstrapped voltage for a floating high-side switch driver stage (220). CB_SMPS signal is a bootstrapped supply voltage which is charged in a natural way when the SMPS is working in its functional mode i.e. its inductor IND node having a swing between the INPUT_SMPS level and GND_SMPS. While the inductor IND is at a low level a dedicated supply voltage on the other plate of the capacitor 262 charges the CB_SMPS capacitor 262. While the IND node is at a high level, CB_SMPS cap provides energy to keep the n-series switch conducting. GND_SMPS is for isolating noisy output current loops from the sensitive control block's current loop (not shown).

Embodiments of the present invention are arranged such that the bandwidth and/or delay in the closed loop of the SMPS 250 is tuned to control the amplitude modulation signal path. It should be appreciated that in the embodiment shown in FIG. 2, both the bandwidth and the delay are tuned. Further it is required to change the mutual delay of the AM and PM signals using a delay block such as that referenced 3 in FIG. 1 to tune the overall performance for the PA application when the loop characteristics are changed. However, in alternative embodiments of the present invention, only one of the bandwidth and delay may be tuneable.

In this circuit, the closed loop bandwidth and its gain response are changed by effectively changing the loop filter unity gain frequency with switchable loop filter component values. The closed loop DC gain is set by adjusting the control voltage (CNTRL_SMPS) to the output voltage (FB_SMPS) ratio. It should be appreciated that well above DC frequency the small signal gain response may also tuned by selecting a ratio between the input supply voltage (INPUT_SMPS) and the reference waveform amplitude, that is the output of the clock circuit 210. The above mentioned together with the selection of the delay provided by the delay block 216 between the driver signals are used to tune the closed loop gain response and group delay characteristics in the AM signal path.

However this is not a stepless method because the loop filter has got limited number of switchable component values. This makes the components with the new settings respond in a different way compared to the previous load and closed-loop response characteristics. It is described in the example below that the AM path gain response is tuned for different band PA (in case of a saturated PA). The mutual delay between the amplitude (envelope) path and PM signal path is dependent on at least one of the used PA, PA mode (linear or saturated as in EER), TX band, TX power level, or the bias current of the power amplifier. At a more generalized level an external component selection, for example inductor 252 and capacitor 256 for different applications may require all or only part of the above methodology.

Alternatively or additionally the delay between the driver signals from the driver circuit 218 and 220 may be tuned to optimise efficiency.

In the prior art, where the high current power switches are controlled in a so-called open loop configuration with only the LC low-pass filter at the output and the pulse width modulator in the input of the high current switches driver stage. With this a relatively limited bandwidth can be achieved in the AM signal path. Embodiments of the present invention use a closed loop configuration. The closed loop configuration enlarges the bandwidth by effectively adding a phase boost. Additionally, in such a closed loop configuration the load at its output affects the signal path response. Accordingly, in embodiments of the present invention, the signal path is handled as an active filter to enable the tuning of the both the bandwidth and delay. The tuning of the delay is provided so that the two concurrent switches i.e., switches 226 and 228 do not conduct simultaneously. This means that a response in the signal path, in some embodiments of the present invention, can be made to steadily respond. By tuning the mutual delay of the AM and RF signals, the overall performance can be improved.

Embodiments of the present invention may have a flat gain response to fast changes in the reference voltage while a wide small signal bandwidth can be sustained under different load modes. Embodiments of the present invention have an arrangement in which the loop filter components can be programmed according to changes in the load condition. For example, there can be a change in the power amplifier or changes in the operating of the power amplifier. The internal delay settings of the switches may be changed. These allow the AM and RF settings to be changed for a transmission path.

The embodiments of the present invention have been described in the context of a Buck or step down type of voltage converter. Such a converter can be used to supply a power amplifier with the envelope of an amplitude modulated signal in the case of EER (envelope elimination and restoration) or ET (envelope tracking) architectures.

It should be appreciated that the required bandwidth will depend on the system in which the transmitter is used. For example, the required bandwidth exceeds 1 megahertz (dynamic range of around 17 dB for a given power level) for the EDGE system which uses 8PSK modulation and exceeds 15 megahertz (dynamic range of about 47 dB for a given power level) for the WCDMA (wide band code division multiple access system).

Embodiments of the present invention are particularly applicable to systems which have a non-constant RF envelope. However embodiments of the invention may be applied in different contexts. In a WCDMA system, a fast enable is needed for Power Tracking PT for efficiency optimization to set the DC supply voltage at the PA collector with the AGC automatic gain control controlling the TX power level. Thus the SMPS gives such a DC level that is enough for the RF peak power and is changed according to the power level.

In embodiments of the present invention, the tune controller 242 also allows the delay to be tuned. In addition to that it allows the selection of the number of transistors in the switches block according for instance to the power level of PA. The switch driver stages are set accordingly to have their driving capability changed as required. This has an effect on the efficiency of the circuit as well as its control loop response time in the time domain when the delay and the loop filter characteristics are set. This means that some embodiments of the present invention are able to deal with different mode conditions, such as different power amplifiers or different power amplifier conditions to control the closed loop bandwidth characteristics in a manner which exceeds open loop characteristics but at the same time keeps the overall efficiency at acceptable levels.

In embodiments of the present invention, the switches 226 and 228 are driven by the pulse width modulating generator (comparator 212 and SR latch 214) and buffered drive chain (drivers 220 and 218) having a level shifting control signal for a floating driver stage (for driving the gate of transistor 228 with signal 224) and a single-ended driver stage (for driving the gate of transistor 240 with signal 222). The delay block 216 which is provided after the comparator 212 and the SR latch 214 and which is in the front of the preamplifier of the drivers 218 and 220 provides a level shift block. In this embodiment, the delay provides a level shift block for the high side switch, that is switch 228. The low side switch, does not usually need a floating driver stage. However, in an alternative embodiment, an arrangement of the driver stages may be changed so more than one floating driver stage may be provided.

In the embodiment shown in FIG. 2, the two switches are of the same conductivity type. Accordingly, a level shifting may be required for the delay controlled signal for a high-side switch but not for a low-side one. However, if the switches are of different conductivity types, then typically no level shifting is required for the delay controlled signal, but in some cases such a level shifting may still be needed when the gate-source voltage of the used switch is needed to be limited.

The loop filter 202 is the function that is used to change the closed loop bandwidth and its gain response by effectively changing the loop filter unity gain frequency with switchable loop filter component values. In the same context the closed loop dc gain is set by adjusting the control voltage (CNTRL_SMPS) to the output voltage (FB_SMPS) while well above dc frequency the small signal gain response may also tuned by selecting a ratio between the input supply voltage INPUT_SMPS and the reference waveform amplitude, that is the clock signal 210. The above mentioned together with the delay selection provided by the delay block 216 between the driver signals are used to tune the closed loop gain response and group delay characteristics in the AM signal path. However this is not a stepless method because the loop filter has got limited amount of switchable component values. This means that the new settings respond in a different way compared to the previous load and closed-loop response characteristics. For this reason, the mutual delay between the amplitude (envelope) path and PM signal path is changed, using a block 3 such as shown in FIG. 1. At the same time, the delay between the signals provided by the first driver 218 and the second driver 220 is tuned. In addition it might be necessary to set the number of transistors to be used inside the switches block according for instance to the power level of PA. At the same time driver_L/driver_H switch driver stages are set accordingly so that their driving capability is changed. This is to improve the efficiency and the control loop response time of the SMPS in the time domain. In embodiments of the present invention, this means it is possible to improve the small signal gain and the group delay of the close loop system at the desired point. This can be observed in an example where the AM path gain response is tuned for different band PA (in case of a saturated PA).

The loop filter 202 can be defined to be the loop gain response which can be measured by opening the loop for instance at the output of the error amplifier 206. This can be used to see or determine the stability of the SMPS.

The closed loop response can be defined to be as follows: FB_SMPS(s)/CNTRL_SMPS(s) at the S domain. s=j*w where j is a vector and w is equal to 2π frequency.

Because the response of the open loop configuration is limited particularly when reaching the unity gain frequency of the closed loop configuration, a load impedance effects the gain response of the closed loop configuration and based on that it also effects the delay characteristics. In the case of embodiments of the present invention applied to a power amplifier, the power amplifier would be that load impedance. It should be appreciated that different transmission bands for example GSM 900, GSM 1800 and WCDMA change the load modes when the power amplifier collector is modulated to control power level. In other words, the same collector value in the GSM 900 band gives twice the output power than it gives in the GSM 1800 band. Thus, the value of the effective load seen at the output is doubled in the EER mode. However, in the ET and linear modes, the effective load is a relatively high ohmic load so that the load is more like a current sink. Thus, it is desirable to have the single path tuneable in an active way. Accordingly, embodiments of the present invention are particularly applicable to scenarios where the transmitter is in a multimode device, such as a user equipment.

In some embodiments of the invention, the wide-bandwidth is such that it is around or exceeds 1 MHz.

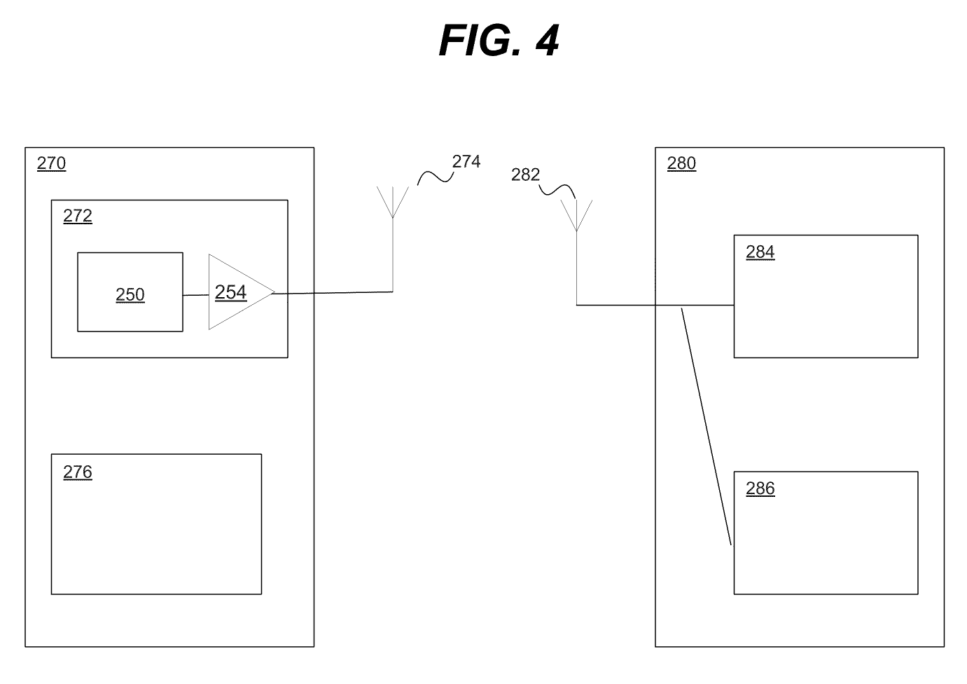

Accordingly, reference is now made to FIG. 4. In FIG. 4, a user equipment 270 is shown. The user equipment comprises a transmitter 272. The transmitter is schematically shown as comprising the SMPS circuit 250 connected to the power amplifier 254. The output of the power amplifier is connected to an antenna 274. It should be appreciated that in practice, the transmitter 272 may include the additional components shown in FIG. 3 as well as some further components. The transmitter is controlled by a controller 276.

In embodiments of the present invention, at least one of the loop filter of the SMPS, delay between the switches, the settings the number of transistors in the switches, the settings of the switch driver stages, gain settings (dc gain and small signal attenuation), and AM/RF mutual delay setting is based on one or more of the following: the used power amplifier (i.e. more than one power amplifier is available), the power amplifier mode, the transmission band, the transmission power level, or the power amplifier biased current. The power amplifier mode can be any suitable mode such as for example a linear or saturated mode. In addition to setting the switching frequency of the SMPS the dither function can be enabled to spread the switching noise if the used combination of Inductor-Capacitor L-C and the above selection settings require such a noise spread to be used.

The user equipment can take any suitable form and may by way of example be a telephone, mobile station, PDA (personal digital system), computer, laptop, multimedia device or any other suitable user equipment. The user equipment 272 has an antenna 274. The signals to be transmitted by the antenna 274 are output by the amplifier 254 with the required power at the required radio frequency. The signals are transmitted to a receiver 284 in for example a base transceiver station 280. Base transceiver station 280 may have an antenna 282 to receive signals along with receiving circuitry 284.

It should be appreciated that embodiments of the present invention can also or alternatively be provided in the base transceiver station. For example, embodiments of the invention can be implemented in transmitter circuitry 284 which is also connected to the antenna 282.

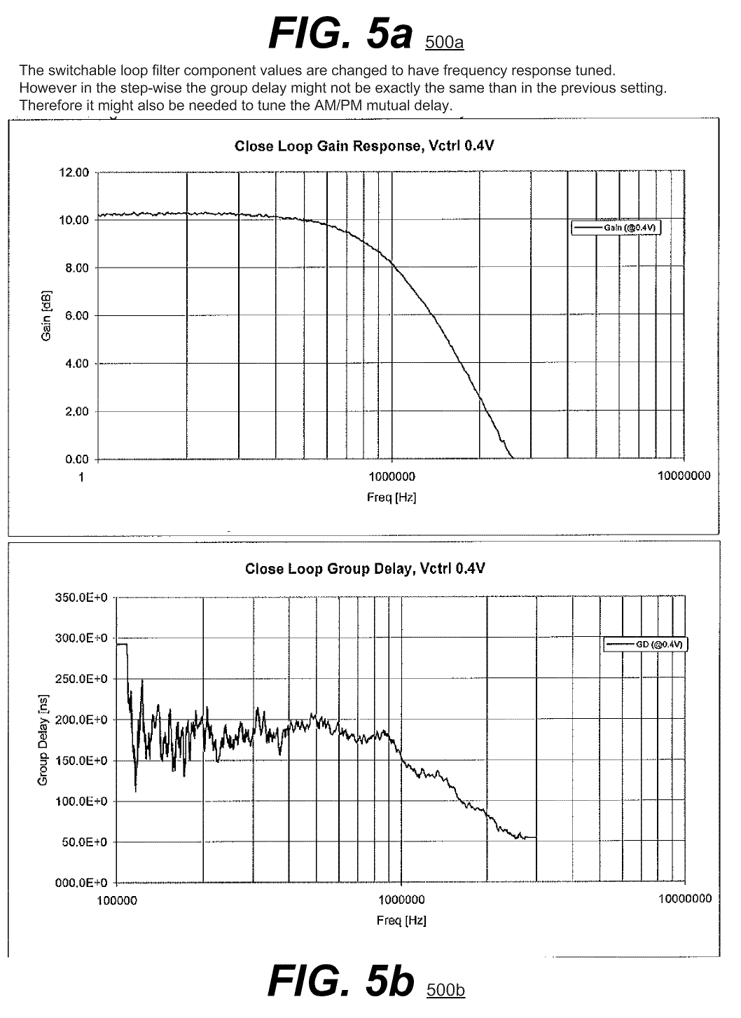

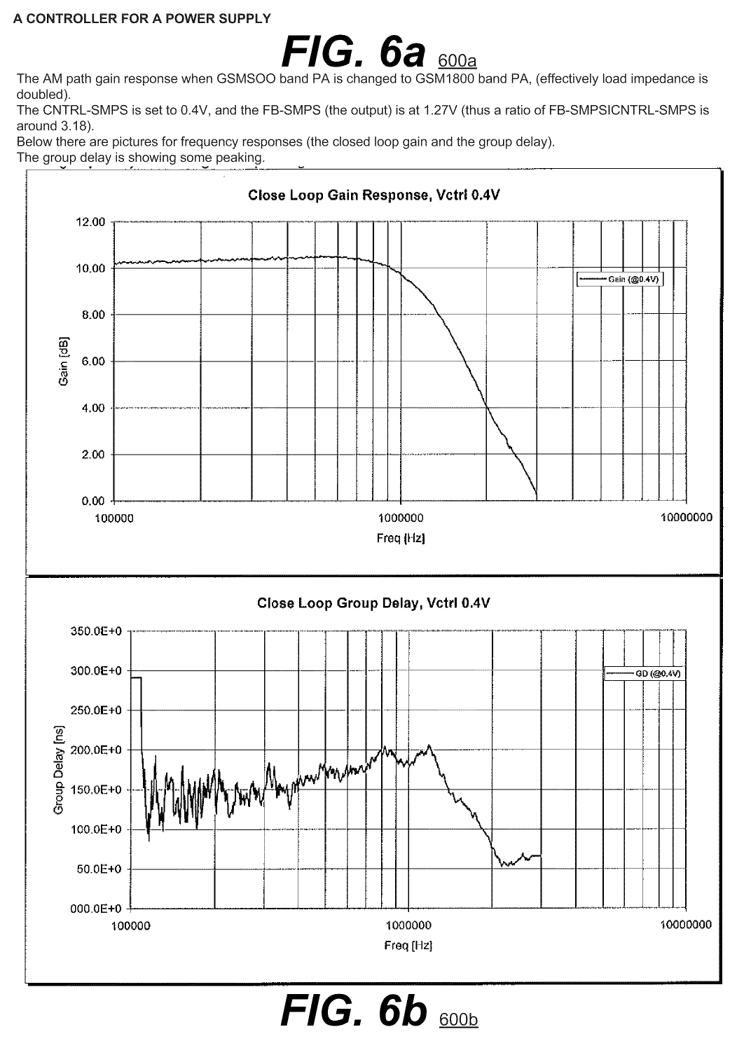

Reference is now made to FIGS. 5a, 5b, 6a and 6b. The curves 600a and 600b shown in FIG. 6 show a closed loop response with small peaking on the pass-band part of the curve. This is corrected in the response 500a and 500b shown in FIG. 5 by tuning in accordance with embodiments of the present invention.

FIGS. 5a and 6a show graphs of gain versus frequency. FIGS. 5b and 6b show graphs of delay versus frequency. Starting with FIG. 6, the AM path gain response when the GSM900 band power amplifier is changed to GSM1900 band power amplifier effectively doubles the load impedance. The CNTRL_SMPS is set to 0.4V and the FB_SMPTS is at 1.27V The ratio of FB_SMPS/CNTRL_SMPS is around 3.18. As shown in FIG. 6 there is some peaking in the group delay.

Compare this to FIG. 5 where the switchable loop filter component values are tuned to have the frequency response tuned. It may be necessary to also tune the AM/PM delay as the group delay may not be exactly the same as in the previous settings used in the scenario of FIG. 6.

Embodiments of the present invention have been described in the context of a transmitter. However, it should be appreciated that embodiments of the present invention have a broader application. Embodiments of the present invention can be used for any suitable application for power control or output voltage control. Embodiments of the present invention have been in the context of the use of the SMPS to provide a power amplifier in the transmission path. However, embodiments of the present invention can be used for any other type of load in any other suitable application.

Embodiments of the present invention have been described in the context of a multimode phone, that is a phone which is able to transmit in accord with more than one mode or standard. However, embodiments of the present invention can be used with a device where there is a single mode but where the power amplifier may need to be controlled differently in different situations.

In preferred embodiments of the present invention, the SMPS circuit is arranged to take is arranged to deal with the AM path, with the RF signal path being taken care by different circuitry, as shown in the context of the arrangement of FIG. 1.

Embodiments of the present invention have been described in the context of a Buck type converter. However, embodiments of the present invention can be used with a boost, Buck boost or similar switch mode power supply.

The various elements in the SMPS 250 can be implemented in the analogue domain, the digital domain or both. The example shown in FIG. 2 is in the analogue domain. However, embodiments of the present invention can be implemented in a digital domain using suitable signal conversion techniques. For example, if some signal preconditioning is required, for example for level shifting, this can be done from the input of the feedback voltage down to the preamplifier stage of the high current drive stage.

Embodiments of the invention are such that various structures are programmable by software. This may require a digital control interface. It should be appreciated that in alternative embodiments of the present invention, the tune controlling can be implemented by any other suitable way, for example via dedicated external control pins.

Some embodiments of the present invention may be at least partially implemented as a computer program. Accordingly, embodiments of the present invention may be partially implemented by computer program executed by a suitable processor or the like.

It should be appreciated at least some of the elements embodying the present invention may be provided on an integrated circuit or a set of integrated circuits (chip set).

It is also noted herein that whilst the above-described exemplifying embodiments of the present invention have been described, there is several variations or modifications which may be made to the disclosed arrangement without parting from the scope of the invention.

What is claimed is:

1. A controller for controlling a load output, said controller comprising:
a closed loop, said closed loop having a least one controllable characteristic; said controller being configured to control said at least one controllable characteristic in response to changes in said load.

2. A controller as claimed in claim 1, wherein said controller is arranged to control an amplitude modulation part.

3. A controller as claimed in claim 1, wherein said controller is arranged to control a dc level.

4. A controller as claimed in claim 1, wherein said changes in said load comprises a change selected from a group consisting of: a change in load conditions, a change in a mode of operation of said load; and a change of the load to a different load.

5. A controller as claimed in claim 1, wherein said load output comprises one of power and voltage,

6. A controller as claimed in claim 1, wherein said controllable characteristic comprises at least one characteristic selected from a group consisting of: gain, bandwidth, delay, switch partitioning, driver partitioning, switching frequency, dither, amplitude modulation; and phase modulation.

7. A controller as claimed in claim 6, wherein said delay comprises the delay between a plurality of driver signals.

8. A controller as claimed in claim 7, wherein said driver signals comprise a high driver signal and a low driver signal

9. A controller as claimed in claim 6, wherein said dither is tunable to be enabled or disabled.

10. A controller as claimed in claim 1, comprising a plurality of power switches.

11. A controller as claimed in claim 10, wherein said controllable characteristic comprises switch partitioning, said switch partitioning comprising tuning the number of said power switches being used.

12. A controller as claimed in claim 10, wherein said a respective one of a plurality of driver signals is arranged to drive a respective one of said power switches.

13. A controller as claimed in claim 1, comprising a loop filter, said controlling means being arranged to control a characteristic of said loop filter.

14. A controller as claimed in claim 13, wherein said characteristic comprises a gain frequency of said loop filter.

15. A controller as claimed in claim 1, wherein said controlling means is configured to control a gain of said closed loop.

16. A controller as claimed in claim 15, wherein said controlling means is configured to control the gain of said closed loop by control a ratio of a control voltage to an output voltage.

17. A controller as claimed in claim 1, wherein said controller comprises a switched mode power supply.

18. A controller as claimed in claim 1, wherein said at least one controllable characteristic is controllable by software.

19. A controller as claimed in claim 1, wherein said controller is arranged to control an output of said load.

20. A controller as claimed in claimed in claim 1, wherein said controller is arranged to control an output to said load.

21. A controller as claimed in claim 1, wherein said load is an amplifier.

22. In combination a controller for controlling a load output, said controller comprising:
a closed loop, said closed loop having a least one controllable characteristic; said controller being configured to control said at least one controllable characteristic in response to changes in said load and an amplifier.

23. A combination as claimed in claim 22, wherein said amplifier is provided in a transmit path.

24. A combination as claimed in claim 22, wherein said controller is arranged to control the amplitude of an output signal of said amplifier.

25. A combination as claimed in claim 22, wherein said combination is arranged to operate in one of a envelope elimination and restoration mode and a envelope tracking mode.

26. A device comprising in combination a controller for controlling a load output, said controller comprising:
a closed loop, said closed loop having a least one controllable characteristic; said controller being configured to control said at least one controllable characteristic in response to changes in said load and an amplifier.

27. A device as claimed in claim 26, wherein said device comprises a user equipment.

28. A device as claimed in claim 26, wherein said device is arranged to be used in a plurality of different modes, said different modes have different amplifier requirements.

29. A chip set comprising a controller for controlling a load output, said controller comprising:
a closed loop, said closed loop having a least one controllable characteristic; said controller being configured to control said at least one controllable characteristic in response to changes in said load.

30. A method for controlling a load output, said method comprising:
controlling at least one controllable characteristic in a closed loop in response to changes in said load.

31. A method as claimed in claim 30, comprising controlling an amplitude modulation part.

32. A method as claimed in claim 30, comprising a dc level.

33. A method as claimed in claim 31, wherein said changes in said load comprises a change selected from a group consisting of: a change in load conditions, a change in a mode of operation of said load; or a change of the load to a different load.

34. A method as claimed in claim 30, wherein said controllable characteristic comprises at least one characteristic selected from a group consisting of: gain, bandwidth, delay, switch partitioning, driver partitioning, switching frequency, dither, amplitude modulation; and phase modulation.

35. A computer program product, comprising a computer usable medium having a computer readable program code embodied therein, said computer readable program code adapted to be executed to implement a method for controlling a load output, said method comprising:
controlling at least one controllable characteristic in a closed loop in response to changes in said load.

36. A controller for controlling a load output, said controller comprising:
a closed loop, said closed loop having a least one controllable characteristic; and
means for controlling said at least one controllable characteristic in response to changes in said load.
